(19) United States
(12) Patent Application Publication
(10) Pub. No.: US 2026/0050566 A1
(43) Pub. Date: Feb. 19, 2026

(54) SCALABLE DECENTRALIZED DATABASE ARCHITECTURE

(71) Applicant: Applied Materials, Inc., Santa Clara, CA (US)

(72) Inventors: She-Hwa Yen, Mountain View, CA (US); Tameesh Suri, San Jose, CA (US); Subramani Kengeri, Santa Clara, CA (US)

(21) Appl. No.: 18/943,024

(22) Filed: Nov. 11, 2024

Related U.S. Application Data
(60) Provisional application No. 63/683,358, filed on Aug. 15, 2024.
(60) Provisional application No. 63/689,011, filed on Aug. 30, 2024.

(51) Int. Cl. G06F 13/40

(52) U.S. Cl. CPC G06F 13/4068; G06F 2213/40

(57) ABSTRACT

Technologies related to database architecture designed for computationally expensive workloads are described. A device includes multiple optical interfaces each configured to couple to different set of processing resources. Optical-to-electrical blocks of the device are each coupled to at least one of the multiple optical interfaces. Memory blocks of the device are each coupled to at least one of the multiple optical-to-electrical blocks.

### CROSS-REFERENCE TO RELATED APPLICATIONS

This application claims the benefit of U.S. provisional Application No. 63/689,011, filed Aug. 15, 2024, the entire contents of which are incorporated by reference. This application claims the benefit of U.S. provisional Application No. 63/683,358, filed Aug. 30, 2024, the entire content of which are incorporated by reference.

### BACKGROUND

In the digital age, databases enable the structured storage, retrieval, and management of vast data across industries. Databases also provide computational power to train artificial intelligence (AI) models. However, databases face challenges such as scalability, data integrity, security, and performance. As data volumes increase and AI models grow more complex, traditional database systems struggle to keep up, and face throughput and scalability problems, which lead to slower performance and higher costs.

### BRIEF SUMMARY

In one aspect, a decentralized computing platform includes a first set of memory resources disposed on a first interposer includes first memory devices, and first interfaces each coupled to at least one of the first memory devices. The decentralized computing platform also includes a first set of processing resources disposed on a second interposer includes one or more first processors, and second interfaces each coupled to at least one of the one or more first processors. The decentralized computing platform also includes a first bridge between the first and second interposers that interconnects the first and second interfaces.

In one aspect, a system includes a memory packlet includes memory units disposed on a first interposer, a processing packlet includes one or more processors disposed on a second interposer, and a bridge connecting the first and second interposers, the bridge includes waveguides to exchange data between the memory packlet and the processing packlet.

In one aspect, an interposer bridge includes a first waveguide, a first coupling device configured to couple the first waveguide to a second waveguide that is part of a first interposer, and a second coupling device configured to couple the first waveguide to a third waveguide that is part of a second interposer.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a decentralized computing platform, according to one embodiment.

FIG. 2 illustrates a memory pool with optical data throughput capabilities, according to one embodiment.

FIG. 3 illustrates an exemplary configuration of a computing platform with interconnected processing and memory packlets, according to one embodiment.

FIG. 4 illustrates an exemplary configuration of a computing platform with interconnected processing and memory packlets, according to one embodiment.

FIG. 5 illustrates an exemplary configuration of a computing platform with interconnected processing and dual-sided memory packlets, according to one embodiment.

FIG. 6 illustrates a decentralized computing platform having packlets, according to one embodiment.

FIG. 7 illustrates a method 700 in accordance with one embodiment.

FIG. 8 illustrates a decentralized computing platform with an interposer bridge, according to one embodiment.

FIG. 9 illustrates a decentralized computing platform with an electrical interposer bridge, according to one embodiment.

FIG. 10 illustrates a decentralized computing platform with an optical interposer bridge, according to one embodiment.

FIG. 11 illustrates an exemplary configuration of a computing platform with interconnected processing and memory packlets, according to one embodiment.

FIG. 12 illustrates an aspect of the subject matter in accordance with one embodiment.

### DETAILED DESCRIPTION

Technologies related to computing platforms designed for computationally expensive workloads are described. Using databases to perform computationally expensive tasks presents several challenges. For example, databases that have a diversity of workloads can experience unsatisfactory performance due to resource underutilization. In many computing platforms, workloads can vary significantly, ranging from simple queries to complex analytical computations. In computing platforms designed to train artificial intelligence (AI) models, workloads related to different models can significantly differ. This diversity often leads to scenarios where some resources, such as processing devices (e.g., computer processing unit (CPU) cores, graphic processing units (GPUs), or other types of processing devices) or memory are over-utilized while others remain underutilized. This imbalance results in inefficient use of system resources, reducing overall system performance (e.g., computational throughput) and increasing operational costs.

Additionally, in centralized computing platforms, the proximity of memory to processing devices can introduce thermal challenges. When memory is placed close to processors to reduce access times, it can lead to increased heat generation. Increased heat generation leads to increased costs and can add complexity to computing platform design and maintenance.

Resource disaggregated computing platforms, also referred to decentralized computing platforms, while offering potential for improved resource utilization, can introduce increased latency overhead. In such platforms, computing, storage, and memory resources are physically separated and connected via connections, such as serializer/deserializer (SERDES) connections. Computing resources are often referred to as processing pools, while memory or other storage resources are often referred to as memory pools. Although this separation between processing and memory pools allows for more flexible resource allocation, it can also introduce latency due to the time required for data to travel between the disaggregated resource pools. This increased latency can significantly impact the performance of computationally intensive tasks, as the delays in data access and processing can accumulate, leading to slower overall system response times.

The memory wall problem also causes issues in decentralized computing platforms. The memory wall problem may be characterized by the disparity between processor speeds and memory access times. This problem encompasses poor energy efficiency and bandwidth scalability for both intra-package and inter-package communication. As processors become faster, the time it takes to access memory does not scale proportionately, leading to a bottleneck. Poor energy efficiency in communication between memory and processors can exacerbate this issue, as more power is consumed for data transfer, reducing the overall energy efficiency of the system. Additionally, the scalability of communication bandwidth is limited, hindering the ability to effectively scale system performance as data volumes and processing demands increase.

Inflexibility of memory access and sharing further complicates the use of computing platforms for demanding computational tasks. Traditional memory architectures often restrict how memory can be accessed and shared among different processors and tasks. This inflexibility can lead to inefficient memory utilization and contention issues, where multiple tasks compete for the same memory resources and cause delays or other types of performance degradation.

Databases that have fixed, non-scalable architectures—whether centralized or decentralized—can pose a significant limitation to performing computationally expensive tasks. Traditional computing platforms are often built on architectures that do not easily scale to accommodate increasing workloads. This rigidity means that to handling more data or more complex computations requires significantly more time. To reduce the computational time on fixed architecture computing platforms, all or a portion of the computing platform might need to be replaced or significantly upgraded, leading to high costs and operational disruptions. This inability to dynamically scale resources as needed significantly hinders the flexibility and efficiency of these traditional computing platforms in handling varying and growing computational demands.

Aspects and embodiments of the present disclosure overcome these deficiencies and others by providing a scalable, modular decentralized computing platform having interconnected sets of processing resources and memory resources. In some instances, a set of processing resources may be referred to as a processing packlet and a set of memory resources may be referred to as a memory packlet. In these instances, the decentralized computing platform provided by the present disclosure may include interconnected processing and memory packlets. As described herein, a packlet may be defined as a device having a substrate upon which resources are disposed. In other words, a packlet has resources—processing or memory resources—that share a same substrate. These resources may be chiplet resources. In at least one embodiment, these chiplet resources may include compute units (e.g., processing cores), or memory units. A packlet may be a processing packlet or a memory packlet. In at least one embodiment, there may be other types of packlets. A processing packlet may refer to packlets that are primarily designed to perform computational tasks or workloads. Processing packlets may have one or more processors that perform these tasks or workloads. Examples of what these processors may be include, but are not limited to, central processing units (CPUs), graphics processing units (GPUs), digital signal processors (DSPs), or the like. Each of these processors may have one or more processing cores. In some embodiments, a processing packlet may include an artificial intelligence (AI) processor (i.e., a processor designed to handle AI-related computations, such as neural network training, inference, and other machine learning tasks). In other words, a processing packlet is a processing device capable of performing computational workloads. A memory packlet may refer to a packlet that is primarily designed to store and provide data to external device(s), such as a processing packlet. Memory packlets may have multiple memory units, such as high bandwidth memory (HBM) or other types of memory. In at least one embodiment, a memory packlet may not have a processor. In other words, processing and memory packlets may be designed so as to complement each other in a decentralized database architecture.

Aspects and embodiments of the present disclosure may include interconnected resource packlets (i.e., processing and memory packlets). These interconnected resource packlets may be referred to as a computing platform or a superset of packlets. This computing platform may have a decentralized structure. In some embodiments, the packlet may include at least nine resource packlets, including five memory packlets and four processing packlets. In other embodiments, the packlet may include more than nine resource packlets. In at least one embodiment, memory packlets of the packlet may be connected to at least one processing packlet of the packlet without intervening circuitry. In another embodiment, memory packlets of the packlet may be connected to at least two processing packlets of the packet without intervening circuitry. This decentralized structure can relax the thermal impact of processing devices on memory operations, as memory packlet(s) are not integrated in a same package as a processing packlet.

In some embodiments, each of these resource packlets may be a single, integrated package containing multiple components. For example, each resource packlet may be an integrated circuit (IC), a single-chip package (SCP), or a multi-chip package (MCP). In these embodiments, components of a respective resource packlet may intercommunicate via intra-package communication techniques and resource packlets may intercommunicate via inter-package communication techniques, as described herein. In another embodiment, a resource packlet may include multiple integrated packages (e.g., multiple blocks of memory that are each separately accessed).

Aspects and embodiments of the present disclosure can provide a memory packlet with intra-package optical communication techniques. This memory packlet may include optical-electrical (O/E) interfaces connected to memory devices (memory blocks) that convert optical signals into electrical signals and vice versa. In at least one embodiment, the memory packlet may be a dual-sided package with two different sets of optical chipsets and memory devices mounted on both top and bottom sides, respectively, of an interposer. The memory packlet may also include one or more optical waveguides coupled between one or more O/E interfaces and one or more optical input/output (I/O) interfaces of the memory packlet. These O/E interfaces may be embedded within the memory packlet. Compute express link (CXL) or a customized link protocol with one or more electrical (or optical) switches may be used to achieve memory pooling within the memory packlet and memory sharing between multiple processing packlets. Such memory pooling and sharing would allow low latency data duplication and exchange at the memory packlet and reduce unnecessary data movement. Optical fiber(s), such as a multi-core fiber, may connect this memory packlet to a processing packlet via this optical interface. In at least one embodiment, different optical fiber(s) may connect respective sides of dual-sided memory packlet to a processing packlet. In some embodiments, the memory packlet can include multiple optical interfaces that each operatively couple the memory packlet to a different processing packlet. These O/E and optical interfaces can enable memory sharing and pooling inside the memory packlet, which can improve data transfer latency, reduce energy consumption, and significantly improve performance massively parallel processing (MPP) applications or other parallel processing applications, such as AI training or inference.

Aspects and embodiments of the present disclosure provide a scalable decentralized computing platform including one or more interconnected packlets. These packlets can be physically or logically connected or reconfigured depending on past, current, or future workload characteristics. A number of packlets that are physically interconnected may be based on a workload requirement or application for which the computing platform is to be used. Once physically interconnected, data traffic between packets can my physically or logically reconfigured based on current or predicted workload requirements. These workload characteristics could include a utilization metric, a bandwidth metric, a latency metric, or a memory synchronization metric of or between packet(s) within the computing platform. Packlets of the decentralized computing platform may be connected via one or more electrical or optical connections. Additionally, resources of a packlet described herein may also be dynamically assigned tasks based on characteristics of past, current, or future workloads. For example, upon receiving a first request to train a first machine learning model (MLM), first and second processing packlets of the packlet may concurrently perform computations using shared memory from a memory packlet corresponding to training the first MLM. Afterwards, upon receiving a second request to train a second MLM and a third request to train a third MLM, the first and second processing packlets may perform concurrent computations to train the second and third MLMs, respectively, using non-shared memory from the memory packlet.

Aspects and embodiments of the present disclosure provide a decentralized computing platform with packlets interconnected by one or more interposer bridges. These interposer bridges may allow the exchange of data between processing and memory packlets. These interposer bridges may be optical bridges configured to transmit optical signals, or electrical bridges configured to transmit electrical signals. The computing platform may include multiple packlets interconnected by one or more optical bridges and/or one or more electrical bridges.

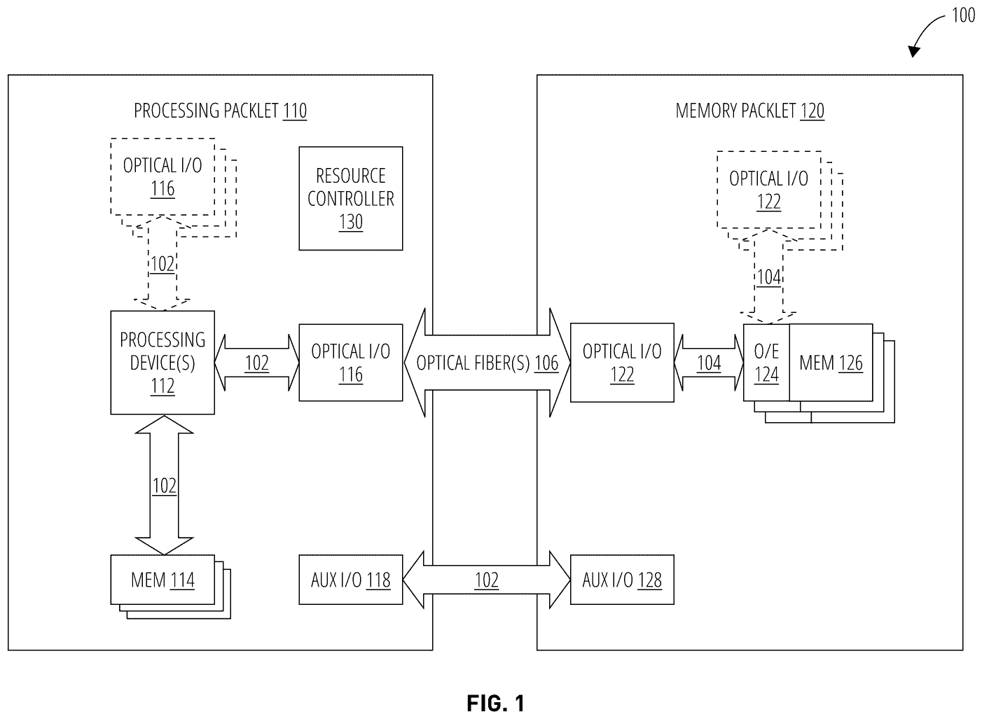

FIG. 1 illustrates a computing platform 100, according to one embodiment. The computing platform 100 may be a decentralized computing platform. The computing platform 100 may include a processing packlet 110 and a memory packlet 120. The processing packlet may be a collection of computational resources, such as CPUs or GPUs, that work together to perform data processing tasks. This processing packlet 110 may be able to dynamically allocate and manage resources based on workload demands, ensuring efficient parallel processing and scalability. Each processing device within the packlet may be able to independently execute operations while coordinating with others to handle data manipulation tasks or distributed queries.

The processing packlet 110 includes processing device(s) 112. These processing device(s) 112 may include CPUs, GPUs, application-specific integrated circuits (ASICs), field-programmable gate arrays (FPGAs), tensor processing units (TPUs), neural processing units (NPUs), data processing units (DPUs), machine learning accelerators, or the like. These processing device(s) 112 may be coupled to one or more local memory blocks 114 via one or more electrical links 102. Each local memory block 114 may be an organized structure of memory cells that store data. In some embodiments, the local memory blocks 114 are memory arrays or memory banks that are accessed independently. Each local memory block 114 may be an independent unit of memory hardware. As used herein, the term “memory block” (e.g., as used to refer to the local memory block 114 and the memory block 126) can refer to various hardware memory structures. For example, “memory block” may denote a memory array, which is the organized grid of memory cells responsible for storing data at the most fundamental level. In another example, “memory block” can refer to a memory bank, a larger subdivision within the memory system that can have multiple memory arrays and can operate independently from other memory arrays. As yet another example, “memory block” can refer to a memory hardware structure that includes multiple memory banks and arrays and has larger data storage. In at least one embodiment, each memory block may have its own dedicated memory controller. Thus, as used herein, “memory block” can refer to a memory device that has a physical memory architecture of any size that is independently accessible and operational. In embodiments where the computing platform 100 is used to train or execute AI models, the local memory block 114 may be used to store intermediate computation results, model parameters, or temporary variables. The local memory block 114 may also be used to store synchronization buffers used to coordinate between different processing packlets 110, such as in a distributed training scenario. In at least one embodiment, the local memory block 114 may also store a local copy of data retrieved from the memory packlet 120.

The processing device(s) 112 may also be coupled to an optical interface 116 via an electrical link 102. This optical interface 116 may be an input/output (I/O) interface that is configured to communicate with the memory packlet 120. In at least one embodiment, the processing device 112 may also include one or more other optical interfaces 116 that are configurable to couple to different memory packlets 120. These other optical interfaces 116 may also be configured to couple to other components of a decentralized computing platform, such as a persistent data storage node, a query engine, a data ingestion or other extraction, transforming, and loading (ETL) tool, or the like.

The memory packlet 120 may be a collective storage resource that provides access to memory for data retrieval and manipulation across one or more processing packlets 110. The memory packlet 120 can help centralize memory management, allowing for efficient allocation and deallocation of memory resources based on dynamic workload requirements or characteristics. The memory packlet 120 can include one or more remote memory blocks 126 that store data that is used by the processing packlet 110 to perform different computational tasks, such as training an AI model. An MLM may be an AI model. The memory packlet 120 may include multiple memory blocks 126. Each memory block 114 may be an organized structure of memory cells that store data. In some embodiments, memory blocks 114 are memory arrays or memory banks that are accessed independently. Each memory block 114 may be an independent unit of memory hardware. Each remote memory block 126 may be coupled to an O/E interface 124 that converts optical signals into electrical signals, and vice versa. Each O/E interface 124 may be coupled to at least one remote memory block 126; however, in at least one embodiment, O/E interfaces 124 may be coupled to more than one remote memory block 126. These O/E interfaces 124 may convert the optical signals received via an optical waveguide 104 and update the data stored within respective remote memory blocks 126 or convert the electrical signals transmitted from respective remote memory blocks 126 into optical signals. In some embodiments, each O/E interface 124 may be connected to a receive (RX) optical waveguide 104 and a transmit (TX) optical waveguide 104. In other embodiments, a same optical waveguide 104 may be used for both TX and RX communication operations. In one embodiment, each waveguide may be connected to at least one O/E interface 124. In another embodiment, each optical waveguide 104 may be connected to at least two O/E interfaces 124. In some embodiments, one or more of these optical waveguides 104 may be wavelength division multiplexing (WDM) waveguides, such as single-mode fibers, coarse WDM fibers, dense WDM fibers, ultra-dense WDM fibers, or the like. In at least one embodiments, one or more of these optical waveguide 104 may be space divisional multiplexing (SDM) waveguides, such as multi-core fibers, few-mode fibers, multi-mode fibers, coupled core fibers, or the like. Additionally, one or more of these optical waveguide 104 may be hybrid waveguides that incorporate WDM and SDM techniques. In some embodiments, these optical waveguides 104 may be planar waveguides, lens waveguides, or another type of waveguide.

In some embodiments, the optical waveguide 104 internal to the memory packlets 120 may utilize WDM, while the optical fiber(s) 106 may utilize SDM. In at least one of these embodiments, the optical fiber(s) 106 may be a multi-core fiber with a plurality of optical cores or an array of single core fibers. In at least one embodiment, optical fiber(s) 106 may be combined with a switch (e.g., a micro-electrical-mechanical system (MEMS) switch) to physically reconfigure the data path depending on current or predicted workload characteristics.

In some embodiments, each O/E interface 124 may be coupled to more than one optical interface 122 of the memory packlet 120. Each of these optical interfaces 122 may be configured to couple to a different processing packlet 110. In another embodiment where the memory packlet 120 includes multiple optical interfaces 122, these different optical interfaces 122 may be coupled to different O/E interfaces 124. In at least one embodiment, compute express link (CXL) or a customized link protocol with one or more electrical (or optical) switches may be used to achieve memory pooling within the memory packlet 120 and memory sharing between multiple processing packlets 110.

In a decentralized server architecture, shared memory operations enable multiple processors to access and manipulate data stored in a common memory space. Latency and throughput are factors in the performance of shared memory operations within a decentralized computing platform because they directly impact the efficiency and speed of data processing and access. Latency refers to the delay between a request for data and the completion of that request, while throughput measures the amount of data that can be processed and transferred within a given timeframe. In decentralized computing platforms, such as one where the computing platform 100 would be employed, multiple processing packlets 110 could access shared memory in certain scenarios (e.g., parallel processing applications, such as AI training or inference), lower latency ensures that data retrieval and storage operations occur swiftly, minimizing waiting times and improving the responsiveness of the system. Higher throughput allows for large volumes of data to be moved quickly between memory and processing units, facilitating the handling of intensive workloads and enabling seamless parallel processing. Together, reduced latency and increased throughput enhance the overall performance, scalability, and reliability of the decentralized computing platform, making it more effective in managing and processing large datasets in real-time applications. If latency or throughput metrics are not satisfactory, several adverse effects can emerge. High latency can result in prolonged data retrieval and storage times, causing processors to idle and leading to inefficient resource utilization and slower processing speeds. This reduced responsiveness can severely impact real-time applications that depend on quick data access and updates. Moreover, low throughput can restrict the volume of data transferred between memory and processing units, creating bottlenecks and congestion that further delay operations. These issues hinder the system's ability to efficiently manage parallel processing tasks, diminishing the benefits of parallelization and slowing down task execution. Additionally, poor performance metrics can increase error rates in data processing and transmission, leading to data corruption and the need for additional error-checking mechanisms. Overall, inadequate latency and throughput significantly degrade the performance, scalability, and reliability of the decentralized computing platform, limiting its capacity to handle large workloads effectively.

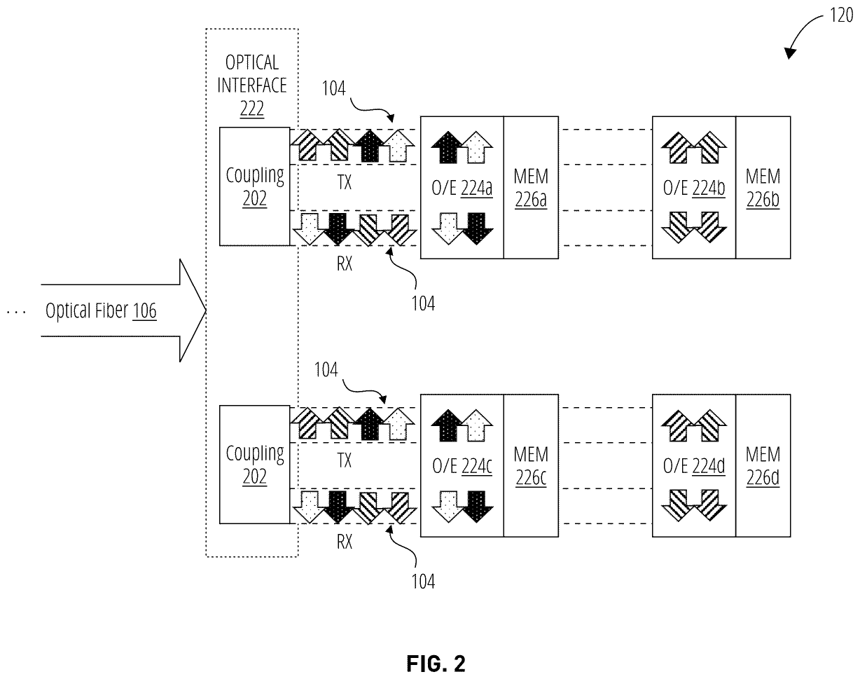

The use of optical waveguides 104 internal to the memory packlets 120, as illustrated in FIG. 2 and otherwise described herein, can help reduce this aforementioned latency and increase throughput of the decentralized computing platform. Adding to the increased throughput and lower latency, optical connections between the processing packlets 110 and the memory packlets 120 (e.g., optical fiber(s) 106 between respective optical interfaces 116, 122) also reduces latency of memory operations requested by the respective processing packlet 110 and increases data throughput between processing and memory packlets 110, 120. By providing an architecture that leads to reduced latency between processing and memory packlets and increased throughput, the computing platform 100 improves shared memory operations of the decentralized computing platform that minimizes the time it takes for processors to retrieve and store data, thereby reducing latency.

The processing packlet 110 may also include an auxiliary interface 118 couplable to an auxiliary interface 128 of the memory packlet 120 via an electrical link 102. In some embodiments, the auxiliary interfaces 118, 128 handshake control commands and status through protocol to establish the electrical and wavelength routing configuration based on traffic load request. At the processing packlet 110, the aggregated bandwidth can be adjusted by either the number of active optical interfaces 116, number of wavelengths used to receive data by each active optical interface 116, or the speed of the electrical links 102 connecting the active optical interfaces 116 to the processing device(s) 112. The memory packlet 120 can aggregate data through wavelength selective optical components and waveguides based on the data load request from each computing packlet package. Unused components of the memory packlet 120 could be put to power saving mode to reduce the power consumption. These auxiliary interfaces 118, 128 may also be used for a number of reasons including but not limited to: handling preprocessing and postprocessing tasks such as data normalization, augmentation, and formatting; implementing error-checking mechanisms to ensure data integrity; distributing workload tasks among resource packlets of the computing platform 100; synchronization between the processing and memory packlets 110, 120; or the like.

The processing packlet 110 may also include a resource management controller 130. In various embodiments, a resource management controller 130 within a decentralized computing platform can serve as a management entity responsible for overseeing and allocating computational resources among distributed processing and memory packlets 110, 120. The resource management controller 130 can monitor system performance metrics and workload demands, which metrics and demands can then be used to facilitate informed decisions about resource distribution. In other words, the resource management controller 130 may ensure that processing power, memory bandwidth, and other critical resources are efficiently utilized across the platform, thereby optimizing overall system performance and maintaining operational efficiency in a decentralized environment.

In at least some embodiment, the resource management controller 130 can dynamically modify resource bandwidth on both the processing packlet 110 and memory packlet 120 based on the tasks currently assigned to the computing platform 100. For example, the resource management controller 130 may increase or decrease a number of remote memory block 126 utilized during a computational task based on the size or complexity of the task. In at least one embodiment, by continuously analyzing the computational requirements and priority levels of active tasks, the resource management controller 130 can adjust the allocation of processor cycles and memory access bandwidth in real time. This dynamic adjustment can allow for the allocation of additional resources to high-priority or resource-intensive tasks while conserving or reallocating resources from lower-priority or less demanding tasks. Such real-time resource management can enhance throughput of the computing platform 100, reduce latency, and help ensure that critical tasks receive enough computational power and memory bandwidth to execute effectively within the decentralized computing platform 100.

FIG. 2 illustrates a memory packlet 120 with optical data throughput capabilities, according to one embodiment. As described above, the memory packlet 120 may be a packlet designed to store and provide data to external devices, such as a processing packlet (such as a processing packlet or processing packlet 110). As illustrated, the memory packlet 120 may include a first O/E interface 224a interfacing with a first remote memory block 226a, a second O/E interface 224b interfacing with a second remote memory block 226b, a third O/E interface 224c interfacing with a third remote memory block 226c, and a fourth O/E interface 224d interfacing with a fourth remote memory block 226d. Each of these O/E interfaces 224a-d may include same or similar features as the O/E interfaces 124 of FIG. 1. Each of these remote memory blocks 226a-d may include same or similar features as the remote memory blocks 126 of FIG. 1.

The memory packlet 120 may include one or more optical waveguides 104. These waveguides may operatively couple the O/E interfaces 224a-d to an optical interface 222. The optical interface 222 may include same or similar features as the optical interface 122 of FIG. 1. In at least one embodiment, each of the O/E interfaces 224a-d may be coupled to the optical interface 222 by a TX optical waveguide 104 and an RX optical waveguide 104. These TX and RX optical waveguides 104 may be coupled together by coupling 202 of the optical interface 222. Each of these optical waveguide 104 connecting the O/E interfaces 224a-d to the optical interface 222 may be wavelength division multiplexing (WDM) waveguides, such as single-mode fibers, coarse WDM fibers, dense WDM fibers, ultra-dense WDM fibers, or the like. A WDM waveguide may be a waveguide designed to carry WDM signals. In some embodiments, these WDM waveguides may be fiber or planar waveguides. In general, WDM is a technique used to transmit multiple signals simultaneously over a single optical waveguide by using different wavelengths (colors) of laser light (or other light source). Each utilized wavelength carries a separate data channel. So, increasing a number of wavelengths utilized also increases throughput and overall data transmission capacity. Multiplexers may be used to combine multiple wavelengths into a single waveguide, while demultiplexers may be used to separate the wavelengths at the receiving end. As illustrated in FIG. 2, these wavelengths may be represented as arrows. Upward arrows may represent transmitted wavelengths, while downward arrows may represent received wavelengths. In at least one embodiment, one or more of these optical waveguides 104 may be space divisional multiplexing (SDM) waveguides, such as multi-core fibers, few-mode fibers, multi-mode fibers, coupled core fibers, or the like. Additionally, one or more of these optical waveguide 104 may be hybrid waveguides that incorporate both WDM and SDM techniques.

In at least one embodiment, each of the O/E interfaces 224a-d may be configured to convert optical data received over respective RX optical waveguides 104 into electrical data. In at least one embodiment, the O/E interfaces 224a-d may convert this optical data into electrical data via a series of steps involving photodetectors and signal processing. When optical signals reach respective O/E interfaces 224a-d, the optical signals may be separated into respective wavelengths which are directed onto photodetectors. Each photodetector may be sensitive to a specific wavelength and convert the incoming light signal into a corresponding electrical signal (e.g., an electrical current or voltage). This electrical signal may then be processed to extract encoded data corresponding to a request, command, or other communication from a processing packlet 110 to respective remote memory blocks 226a-d. Each of the O/E interfaces 224a-d may also convert electrical data received from respective remote memory blocks 226a-d into optical data. This electrical-to-optical conversion may include causing the electrical data to modulate the output of laser diodes or other light sources. Each laser diode (or other light source) may emit light internally or externally at a specific wavelength, and modulating the laser diodes (or other light sources) can encode the electrical data onto this light by varying its intensity, phase or frequency.

In some embodiments, each of the optical waveguides 104 may couple more than one of the O/E interfaces 224a to the optical interface 222. For example, a first set of TX/RX optical waveguides 104 can couple O/E interfaces 224a-b to the optical interface 222 while a second set of TX/RX optical waveguides 104 can coupled O/E interfaces 224c-d to the optical interface 222. In some embodiments, each of the optical waveguides 104 may be capable of concurrently transmitting optical data over at least four different wavelengths. In at least one embodiment, each of the optical waveguides 104 may be designed to be capable of concurrently transmitting optical data over any number of specified wavelengths. In some embodiments, each of the O/E interfaces 224a-d may be capable of handling optical data transmissions over at least two wavelengths. In at least one embodiment, each of the O/E interfaces 224a-d may be capable of handling optical data transmissions over any number of specified wavelengths.

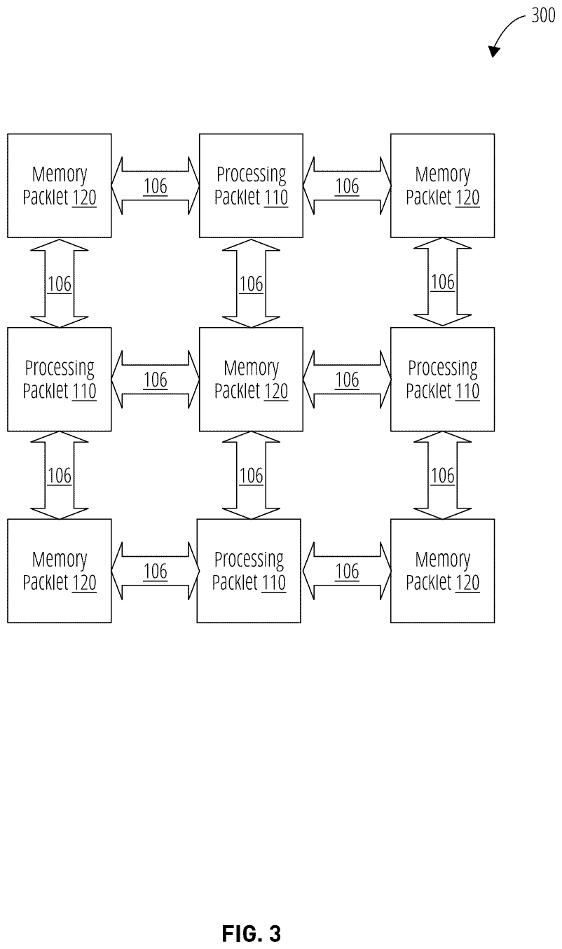

FIG. 3 illustrates an exemplary configuration of a computing platform 300 with interconnected processing and memory packlets 110, 120, according to one embodiment. In at least one embodiment, the computing platform 300 may be a superset of resource packlets. The computing platform 300 may include some or all of the features of the computing platform 100 as described above in FIG. 1. In some embodiments, the computing platform 300 may include more than one processing packlet 110 and more than one memory packlet 120. Each of the memory packlets 120 may be capable of connecting to multiple processing packlets 110 via optical fiber(s) 106. For example, a first memory packlet 120 may be coupled to one or more of a first processing packlet 110 (e.g., via a first optical interface of the first memory packlet 120 and a second optical interface of the first processing packlet 110), a second processing packlet 110 (e.g., via a third optical interface of the first memory packlet 120 and a fourth optical interface of the first processing packlet 110), a third processing packlet 110 (e.g., via a fifth optical interface of the first memory packlet 120 and a sixth optical interface of the first processing packlet 110), or a fourth processing packlet 110 (e.g., via a seventh optical interface of the first memory packlet 120 and an eighth optical interface of the first processing packlet 110). In at least one embodiment, memory packlets 120 of the computing platform 300 may be capable of coupling to more than four processing packlets 110 via optical fibers 106. Similarly, each of the processing packlet 110 may be capable of connecting to multiple memory packlets 120 via the optical fibers 106. For example, a first processing packlet 110 may be coupled to one or more of a first memory packlet 120, a second memory packlet 120, and a third memory packlet 120. In at least one embodiment, processing packlets 110 of the computing platform 300 may be capable of coupling to more than four processing packlets 110 via optical fibers 106. In some embodiments, the computing platform 300 may be designed such that processing packlets 110 and memory packlets 120 are directly connected to each other via the optical fibers 106. The computing platform 300 may also be designed so that processing packlets 110 are not directly connected to each other without an intervening memory packlet 120. Similarly, the computing platform 300 may be designed so that memory packlets 120 are not directly connected to each other without an intervening processing packlet 110.

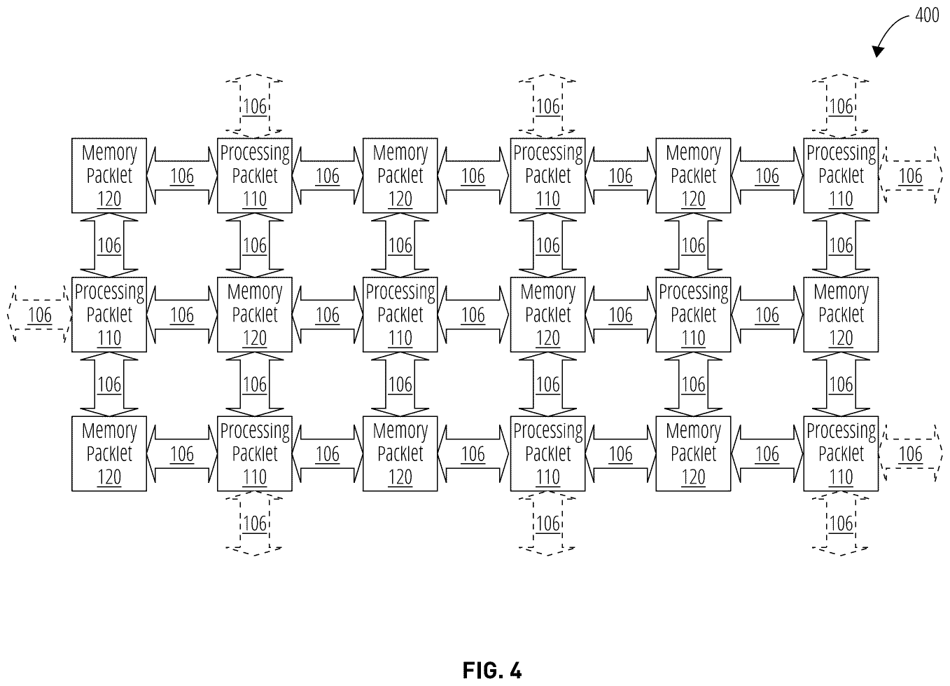

FIG. 4 illustrates an exemplary configuration of a computing platform 400 with interconnected processing and memory packlets, according to one embodiment. The computing platform 400 may include some or all of the features of the computing platform 100 as described above in FIG. 1 or the computing platform 300 as described in FIG. 3. As one of skill in the art would appreciate, the computing platform 400 may have a configurable number of processing and memory packlets 110, 120 interconnected by optical fibers 106. In one embodiment, the computing platform 400 may include a fabric of interconnected processing and memory packlets 110, 120 having a first number of processing packlets 110 and a second number of memory packlets 120. As used herein, a logical fabric may refer to resource packlets 110, 120, and logical connections between them (e.g., to complete a given task or workload) at a given moment of time. This fabric may change as different portions of the computing platform 400 are utilized based on workload requirements or characteristics. As such, it can be understood that, in at least one embodiment, these first and second numbers of resource packlets 110, 120 may be modular; in other words, the number of resource packlets 110, 120 utilized for a given task or workload may be physically or logically customizable. For example, for a larger computational task, two or more processing packlets 110 may be tasked with parallelly performing the larger computational task using shared data from one or more memory packlets 120. Thus, for this larger computational task, a first number of resource packlets 110, 120 would be used for the larger computational task. On the other hand, for a smaller computational task, one processing packlet 110 may be tasked with performing the smaller computational task using data from a single memory block (e.g., remote memory block 126). Thus, for this smaller computational task, only two resource packlets 110, 120, less than the first number of resource packlets 110, 120, would be used for the smaller computational task.

In at least one embodiment, memory packlets 120 may be coupled to each other via optical fibers through an optical switch that would allow memory packlets 120 to swap stored data with other memory packlets. This may allow further flexibility and resource management based on current or future computational tasks assigned to the computing platform 400.

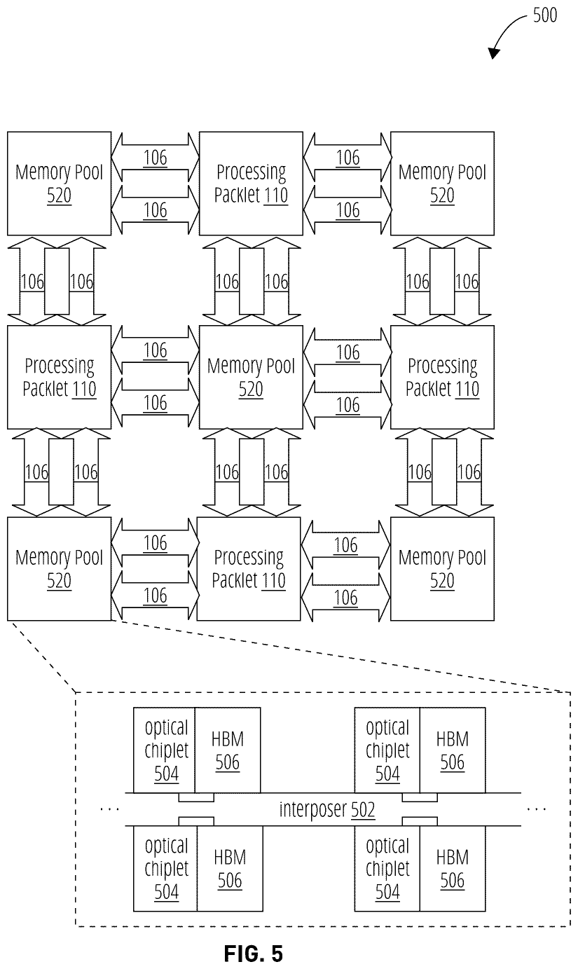

FIG. 5 illustrates an exemplary configuration of a computing platform 500 with interconnected processing packlets 110 and dual-sided memory packlets 520, according to one embodiment. These interconnected processing packlets 110 and dual-sided memory packlets 520 may each be packlet, as described herein. The computing platform 500 may include some or all of the features of the computing platform 100 as described above in FIG. 1, the computing platform 300 as described above in FIG. 3, or the computing platform 400 as described above in FIG. 4. The memory packlet 520 may include same or similar features as the memory packlet 120 as described herein. Each dual-sided memory block 520 may be an organized structure of memory cells that store data. In some embodiments, dual-sided memory blocks 520 are memory arrays or memory banks that are accessed independently. Each dual-sided memory block 520 may be an independent unit of memory hardware. As one of skill in the art would appreciate, the computing platform 400 may have a configurable number of processing and memory packlets 110, 120 interconnected by optical fibers 106.

In some embodiments, the memory packlet 520 may be a dual-sided package with components or circuitry mounted (or otherwise disposed) on a top portion of the package and a bottom portion of the package opposite of the top portion. By positioning components or circuitry on both sides of the package, available space on the package is optimized and can have a higher component density than a single-sided package. In at least one embodiment, the top and bottom portions of the package may be separated by an interposer 502. This interposer 502 can be a substrate that provides electrical connections, optical connections, or any combination thereof between different components, acting as an intermediary layer in electronic packaging. In a dual-sided package, the interposer 502 can be placed between the top and bottom portions to facilitate communication and signal routing between components mounted on both surfaces. In embodiments where the interposer 502 incorporates insulating layers, materials, or thicknesses, the interposer 502 may insulate the top and bottom portions of the memory packlet 520 from each other and provide a base from which to mount (or otherwise place) components or circuitry of the top and bottom portions.

The top and bottom portions of the memory packlet 520 may each include high bandwidth memory (HBM) 506. This HBM 506 may include same or similar features as the remote memory blocks 126 or remote memory blocks 226a-d, as described herein. The HBM 506 may be any type of suitable memory including double data rate (DDR) memory or a hybrid memory combination. The top and bottom portions of the memory packlet 520 may also include optical chiplets 504, which may include same or similar features of the O/E interfaces 124 or O/E interfaces 224a-d as described herein.

In at least one embodiment, different optical fibers 106 may respectively couple the top and bottom portions of a respective memory packlet 520 to a respective processing packlet 110. In one embodiment, one multi-core fiber may house each optical signal corresponding to data from the different HBMs 506 on the top and bottom portions of the respective memory packlet 520. In another embodiment, a first multi-core fiber may be used to send optical signals to and from the top portion of the respective memory packlet 520, while a second multi-core fiber may be used to send optical signals to and from the bottom portion of the respective memory packlet 520.

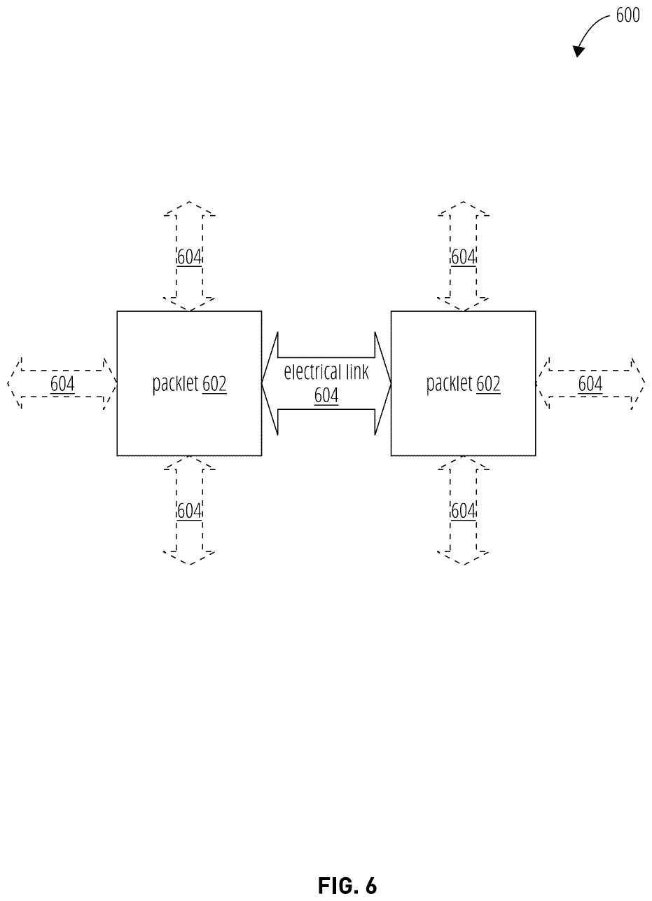

FIG. 6 illustrates a decentralized computing platform 600 having packlets 602, according to one embodiment. The packlets 602 may include some or all of the features of the computing platform 100 as described above in FIG. 1, the computing platform 300 as described above in FIG. 3, the computing platform 400 as described above in FIG. 4, or the computing platform 500 as described above in FIG. 5.

In at least one embodiment, packlets 602 may be interconnected by electrical links 604, as illustrated. In another embodiment, packlets 602 may be interconnected using optical means, such as the optical fiber(s) 106 described herein. In some embodiments, a respective packlet 602 may be connected to more than one other packlet 602. A number of packlets 602 within the decentralized computing platform 600 may be physically or logically customizable depending on requirements or characteristics of past, current, or future workloads.

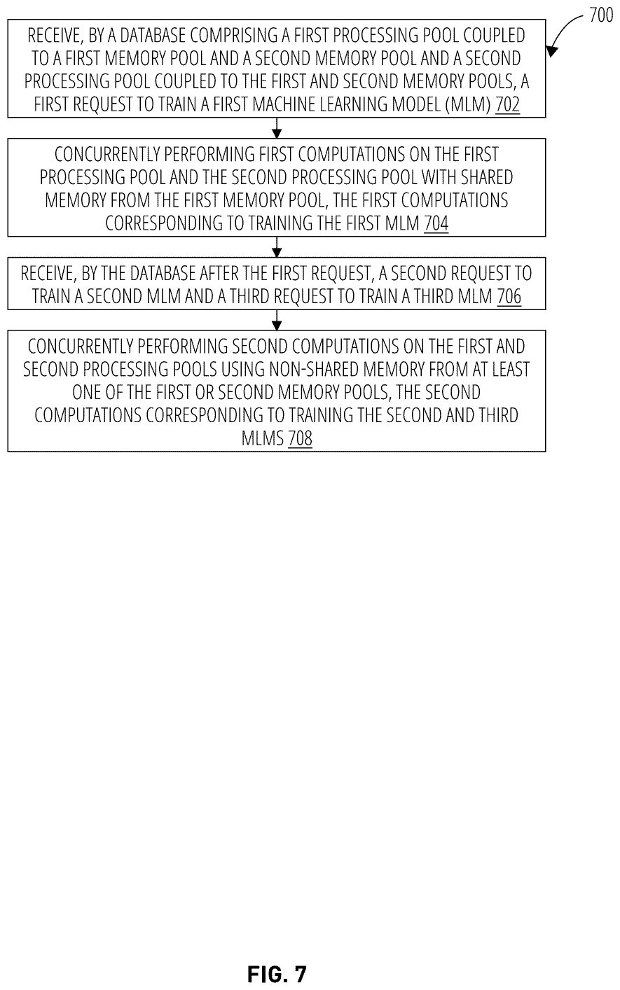

FIG. 7 is a method 700 depicting resource allocation of a computing platform, according to one embodiment. The method 700 may be performed by processing logic that may comprise hardware (e.g., circuitry, dedicated logic, programmable logic, microcode, etc.), software (e.g., instructions run on a processing device to perform hardware simulation), firmware, or a combination thereof. This processing logic may control operations of a computing platform, such as the decentralized computing platform 600 or any other computing platform including a computing platform 100, computing platform 300, computing platform 400, computing platform 500, or packlet 602, as described herein. The method 700 can be controlled at least partially by other devices, such as a cloud computing platform or processor having one or more processing devices.

At block 702, a processing logic (e.g., a processing device) may receive a first request to train a first machine learning model (MLM).

At block 704, the processing logic may cause first computations to be concurrently performed on first and second processing packlets with shared memory from a first memory packlet. A computing platform may include the first processing packlet coupled to the first memory packlet and a second memory packlet and the second processing packlet coupled to the first and second memory packlets. The first and second processing packlets may be the same or similar as the processing packlets 110 as described herein. The first and second memory packlets may be the same or similar as the memory packlets 120 or memory packlets 520, as described herein. These first computations may correspond to training the first MLM.

At block 706, the processing logic may receive a second request to train a second MLM and a third request to train a third MLM. These second and third requests may be received after the first request.

At block 708, the processing logic may cause second computations to be concurrently performed by the first and second processing packlets using non-shared memory from at least one of the first or second memory packlets. These second computations may correspond to training the second and third MLMs.

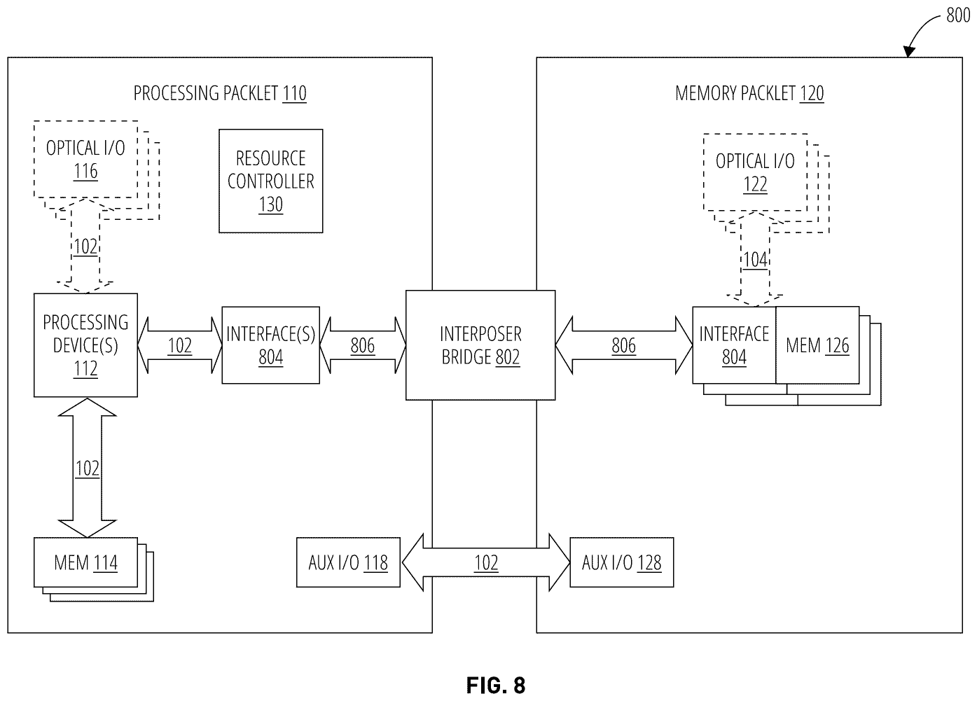

FIG. 8 illustrates a decentralized computing platform 800 with an interposer bridge 802, according to one embodiment. One or more features of the computing platform 800 may be the same or similar to the computing platform 100 described herein. Each of the processing packlet 110 and memory packlet 120 may have one or more interfaces 804 that facilitate an exchange of data between the processing packlet 110 and the memory packlet 120 via the interposer bridge 802. These interfaces 804 may be connected to the interposer bridge 802 via one or more coupling devices 806.

The interposer bridge 802 may be passive or include active components. In various embodiments, the interposer bridge 802 may provide one or more communication channels between the processing packlet 110 and the memory packlet 120, which may be disposed on separate interposers. These one or more communication channels may be referred to as interconnects. The interposer bridge 802 may be any type of suitable interposer bridge, including but not limited to a silicon bridge, which utilize silicon substrates to form interconnections; an embedded multi-die interconnect bridges (EMIB), or a fan-out bridge. The interposer bridge 802 may be fabricated from various materials suitable for electronic applications. These materials may include, but are not limited to silicon, offering high electrical conductivity and compatibility with existing semiconductor processes; organic substrates, which provide flexibility and cost advantages for certain applications; and glass, which typically has substantial electrical insulation properties and thermal stability. The selection of material may depend on factors such as desired electrical performance, thermal management requirements, and manufacturing considerations.

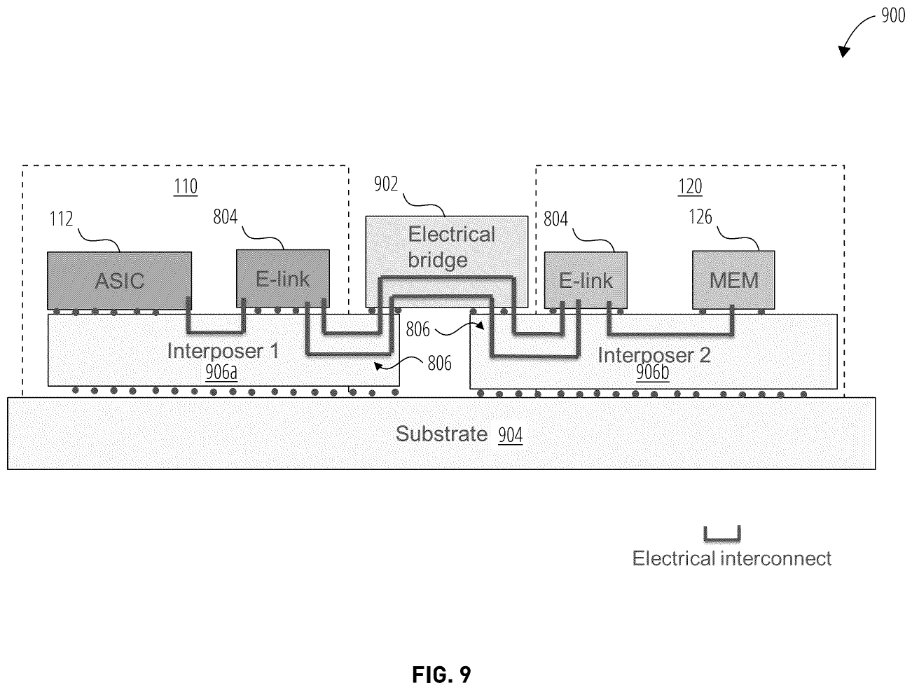

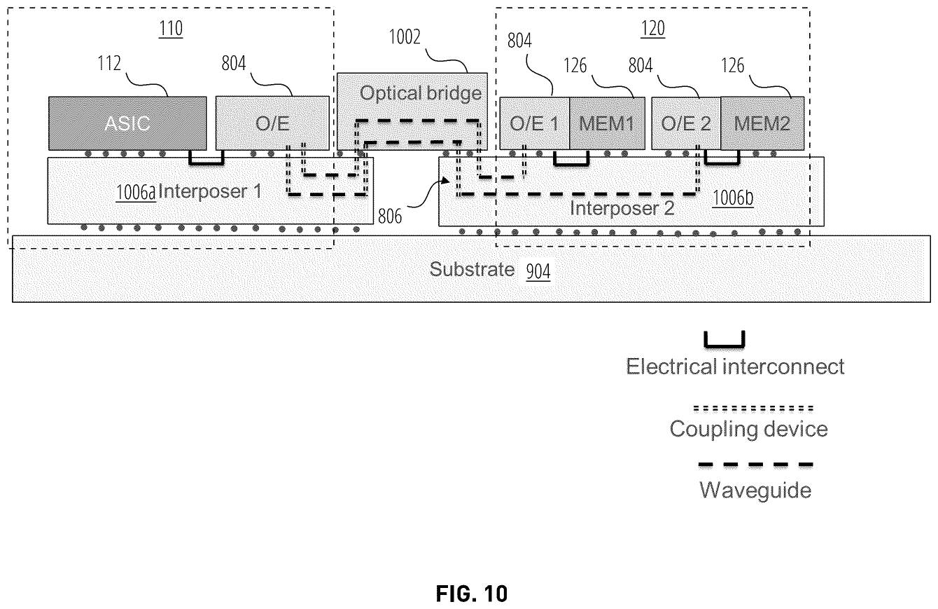

The interfaces 804 may any type of suitable interface or converter that would allow data to be exchanged between the processing packlet 110 and the memory packlet 120 via the interposer bridge 802. In embodiments where the interposer bridge 802 transmits data optically (as illustrated in FIG. 10 below), the interfaces 804 may be O/E interfaces, as described above with respect to O/E interfaces 124 described herein. In embodiments where the interposer bridge 802 transmits data electrically (as illustrated in FIG. 9 below), the interfaces 804 may an electrical links (E-link), such as a serializer/deserializer (SerDes) converter, or device-to-device (D2D) links.

The coupling devices 806 may be any suitable component that allows data to be changed between the interfaces 804 via the interposer bridge 802. In embodiments where the interposer bridge 802 transmits data optically (as illustrated in FIG. 10 below), the coupling devices 806 may provide control over a directional flow of optical signals. As such, the coupling devices 806 may be a type of component that can control directional flow of optical signals. Components that can control directional flow of optical signals may include, but are not limited to, mirror devices, grating devices, or evanescent devices. A mirror device may be configured to reflect optical signals along predetermined paths by utilizing reflective surfaces positioned at specific angles. This allows the optical signals to be efficiently redirected and facilitates precise directional control over optical signal routing while maintaining signal integrity. A grating device may be employed to diffract optical signals based on the principles of diffraction. The grating device can be designed with specific grating periods and orientations to disperse or direct optical signals at desired angles or wavelengths. This enables selective routing of different wavelengths or modes of optical signals, supporting functionalities such as wavelength multiplexing or demultiplexing within the device. An evanescent device can be used to control the directional flow of optical signals through evanescent field coupling. By placing optical waveguides or components in close proximity, the evanescent fields overlap, allowing optical signals to transfer between the components without direct physical connections.

FIG. 9 illustrates a decentralized computing platform 900 with an electrical interposer bridge 902, according to one embodiment. The computing platform 900 may include one or more of the features of the computing platform 100 or the computing platform 800 as described herein. The electrical bridge 902 may be configured to passively exchange data between the interfaces 804 of the processing packlet 110 and the memory packlet 120. In other words, the electrical bridge 902 may be configured to optically couple the interfaces 804 of the processing packlet 110 and the memory packlet 120. Electrical interconnects, such as metal vias, within interposers 906a, 906b may be used to connect the interfaces 804 to the electrical bridge 902. Components of the processing packlet 110 (the processing device 112 and interface 804) and the memory packlet 120 (the remote memory block 126 and interface 804) may also be interconnected via electrical interconnects.

The electrical bridge 902 may be made of glass, silicon, or another organic or inorganic material suitable for electronic functionality. The electrical bridge 902 may include multiple interconnect layers, such as redistribution layers (RDL), through which data may be routed between the processing packlet 110 and the memory packlet 120. Each RDL may include a first terminal couplable to a first interface 804 of the processing packlet 110 and a second terminal couplable to a second interface 804 of the memory packlet 120. Each of the interfaces 804 may be E-links, as described above, which may be SerDes converters, D2D links, or another suitable E-link.

Each of the interposers 906a, 906b may be disposed on a substrate 904 or other suitable material. These interposers 906a, 906b can be implemented in various configurations, including 2.5-dimensional (2.5D) and three-dimensional (3D) architectures. These interposers 906a, 906b can serve as intermediary connection platforms that facilitate electrical and mechanical integration between semiconductor devices and the underlying substrate. The interposers 906a, 906b may be fabricated from a variety of materials suitable for electronic applications. Possible materials include, but are not limited to glass, which offers substantial electrical insulation and thermal stability; silicon, which provides compatibility with many conventional semiconductor processes and high thermal conductivity; and organic substrates, which offer flexibility and cost-effectiveness. The selection of material may depend on factors including but not limited to thermal performance requirements, electrical properties, and manufacturing considerations.

In some embodiments, more than one electrical bridge 902 may connect the processing packlet 110 to the memory packlet 120. In at least one embodiment, each electrical path integrated within the electrical bridge 902 may correspond to a different remote memory block 126. The electrical bridge 902 may have multiple electrical paths.

According to embodiments, the electrical bridge 902 may be connected or coupled to the interposers 902a, 902b via hybrid bonding. Hybrid bonding is an interconnect technology in microelectronics that enables the direct joining of semiconductor devices without the use of traditional solder bumps. This technique involves the simultaneous bonding of both dielectric materials and embedded conductive pads, typically copper, to form mechanical and electrical connections at the die level (e.g., with interposers, such as interposer 902a, 902b). In the hybrid bonding process, surfaces of the devices to be bonded are prepared through chemical-mechanical polishing to achieve flat and smooth surfaces. This preparation facilitates intimate contact between the dielectric materials and the embedded conductive pads, which are flush with the surface, which eliminates protrusions and helps create a bumpless interface.

The alignment of the surfaces that are to be bonded via hybrid bonding is performed with precision equipment to help ensure that their respective embedded pads and dielectric surfaces are matched. When these surfaces come into contact, intermolecular forces initiate bonding at room temperature. Concurrently, the embedded conductive pads make contact, and a subsequent thermal annealing process promotes atomic diffusion at the interface of the conductive pads, forming a strong metallic bond. The bonded assembly undergoes thermal treatment to strengthen both the dielectric and metallic bonds, resulting in a unified structure with seamless electrical and mechanical connections. These electrical and mechanical connections between the bonded surfaces may be orthogonal to a direction which the surfaces extend. For example, the surfaces may extend in a horizontal direction, while the electrical and mechanical connections between the bonded surfaces may extend in a vertical direction.

By embedding the conductive pads and eliminating solder bumps, hybrid bonding facilitates more uniform height variations across the bonded surfaces, enhancing mechanical stability and planarity. The absence of solder bumps allows for a reduced pitch between interconnects, enabling a higher density of communication channels (i.e., interconnects). This reduction in pitch facilitates more signals to pass between devices in a given area, supporting the scaling of communication channels. A higher density of communication channels corresponds to a higher throughput between the processing packlet 110 and the memory packlet 120 via the electrical bridge 902. Moreover, direct metallic bonds between conductive pads minimize the resistive and capacitive parasitic effects commonly associated with solder-based interconnects. This results in improved electrical performance, including faster signal transmission and lower power consumption.

Hybrid bonding can be effectively employed to connect the electrical bridge 902 to the first interposer 906a and the second interposer 906b. In this configuration, the electrical bridge 902 may be fabricated with embedded hybrid bonding pads (e.g., first terminals, second terminals) in two different locations. These two different locations may be on a same surface of the electrical bridge 902, or may otherwise be on parallel surfaces. The locations of hybrid bonding pads on the electrical bridge 902 may have corresponding connection points on the interposers 906a, 906b. The interposers 906a, 906b may be similarly fabricated with embedded pads aligned to match those on the electrical bridge 902. The bridge and interposers may be brought into contact and bonded under a controlled process as described above. Connections created by the hybrid bonding may be in a direction orthogonal to a direction that the interposers 906a, 906b extend.

FIG. 10 illustrates a decentralized computing platform 1000 with an optical interposer bridge 1002, according to one embodiment. The computing platform 1000 may include one or more of the features of the computing platform 100 or the computing platform 800 as described herein. The optical bridge 1002 may be configured to passively exchange data between the interfaces 804 of the processing packlet 110 and the memory packlet 120. In other words, the optical bridge 1002 may be configured to optically couple the interfaces 804 of the processing packlet 110 and the memory packlet 120. Waveguides may be integrated into interposers 1006a, 1006b may be used to connect the interfaces 804 to the optical bridge 1002. Coupling devices 806 may be used to connect the waveguides integrated into the interposers 1006a, 1006b to one or more waveguides integrated within the optical bridge 1002. In embodiments where the interposer bridge 802 is an optical bridge 1002, the coupling device 806 may provide directional control over optical signals exchanged between the processing packlet 110 and memory packlet 120. As explained with respect to FIG. 8, these coupling device 806 may be components such as mirror devices, grating devices, or evanescent devices. A mirror device may be configured to reflect optical signals along predetermined paths by utilizing reflective surfaces positioned at specific angles. This allows the optical signals to be efficiently redirected and facilitates precise directional control over optical signal routing while maintaining signal integrity. A grating device may be employed to diffract optical signals based on the principles of diffraction. The grating device can be designed with specific grating periods and orientations to disperse or direct optical signals at desired angles or wavelengths. This enables selective routing of different wavelengths or modes of optical signals, supporting functionalities such as wavelength multiplexing or demultiplexing within the device. An evanescent device can be used to control the directional flow of optical signals through evanescent field coupling. By placing optical waveguides or components in close proximity, the evanescent fields overlap, allowing optical signals to transfer between the components without direct physical connections. In at least some embodiments, the optical bridge 1002 includes terminals (e.g., first terminals, second terminals) that connect waveguides integrated within the optical bridge 1002 to the interposers 1006a, 1006b. These terminals may allow optical signals travelling between the processing and memory packlets 110, 120 to pass between the optical bridge 1002 and the interposers 1006a, 1006b in a direction orthogonal to a direction which the interposers 1006a, 1006b extend. These terminals may be part of the coupling devices 806 between the optical bridge 1002 and the interposers 1006a, 1006b. For example, if the interposers 1006a, 1006b extend in a horizontal direction, the coupling devices 806 may extend in a vertical direction, which causes the optical data to pass between the optical bridge 1002 and the interposers 1006a, 1006b in the vertical direction.

Each of the interposers 1006a, 1006b may be disposed on a substrate 904 or other suitable material. These interposers 906a, 906b can be implemented in various configurations, including 2.5-dimensional (2.5D) and three-dimensional (3D) architectures. These interposers 1006a, 1006b can serve as intermediary connection platforms that facilitate electrical and mechanical integration between semiconductor devices and the underlying substrate. The interposers 1006a, 1006b may be fabricated from a variety of materials suitable for electronic applications. Possible materials include, but are not limited to glass, which offers substantial electrical insulation and thermal stability; silicon, which provides compatibility with many conventional semiconductor processes and high thermal conductivity; and organic substrates, which offer flexibility and cost-effectiveness. The selection of material may depend on factors including but not limited to thermal performance requirements, electrical properties, and manufacturing considerations.

In some embodiments, more than one optical bridge 1002 may connect the processing packlet 110 to the memory packlet 120. According to embodiment, each waveguide integrated within the optical bridge 1002 may correspond to a different set of remote memory blocks 126. In at least one embodiment, each waveguide integrated within the optical bridge 1002 may correspond to a different remote memory block 126. The optical bridge 1002 may have multiple waveguides (e.g., a multi-core waveguide, or another suitable waveguide implementation that utilizes spatial division multiplexing (SDM)), or may combine optical signals received from different interfaces 804 (here, O/E interfaces 124) as described herein (e.g., a waveguide implementation that utilizes WDM). In various embodiments, the optical bridge 1002 may utilize a waveguide implementation that utilizes both SDM and WDM to varying degrees.

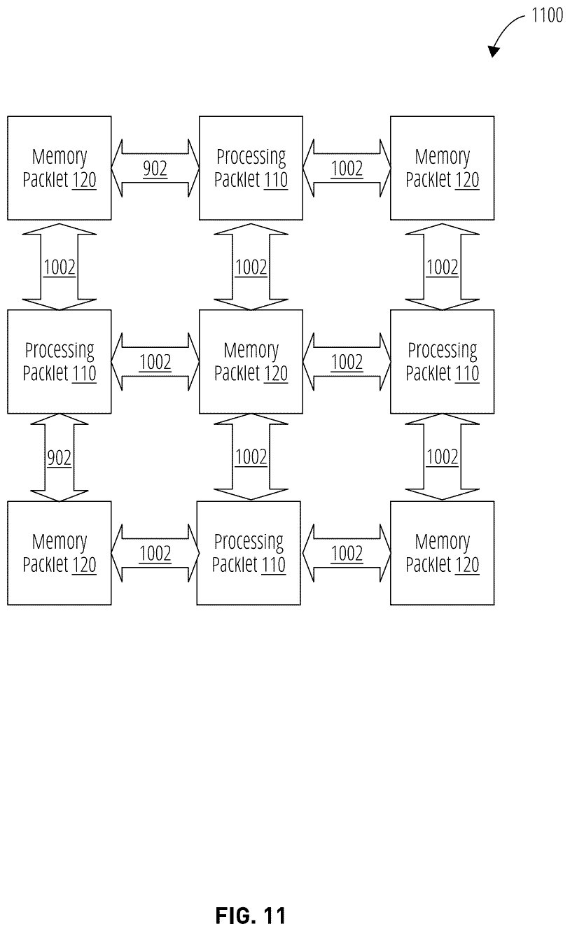

FIG. 11 illustrates an exemplary configuration of a computing platform 1100 with interconnected processing and memory packlets 110, 120, according to one embodiment. In at least one embodiment, the computing platform 1100 may be a superset of resource packlets. The computing platform 1100 may include some or all of the features of computing platforms 100, 500, 900, 1000 as described above in FIG. 1. In some embodiments, the computing platform 1100 may include more than one processing packlet 110 and more than one memory packlet 120. Each of the memory packlets 120 may be capable of connecting to multiple processing packlets 110 via interposer bridges 802. These interposer bridges 802 may be electrical bridges 902 or optical bridges 1002. The selection of which type of interposer bridge 802 to use (e.g., electrical bridge 902 or optical bridge 1002) may depend on factors including but not limited to thermal performance requirements, manufacturing considerations, or hardware limitations. The computing platform 1100 shows an exemplary computing platform 1100 with processing and memory packlets 110, 120 interconnected with both electrical bridges 902 and optical bridges 1002. However, in at least some embodiments, each interconnection between processing and memory packlets 110, 120 may be all electrical bridges 902 or all optical bridges 1002.

In the embodiment illustrated by the computing platform 1100, a first memory packlet 120 may be coupled a first processing packlet 110 via a first optical bridge 1002 and a second processing packlet 110 via a first electrical bridge 902. The second processing packlet 110 may be coupled to a second memory packlet 120 via a second optical bridge 1002.

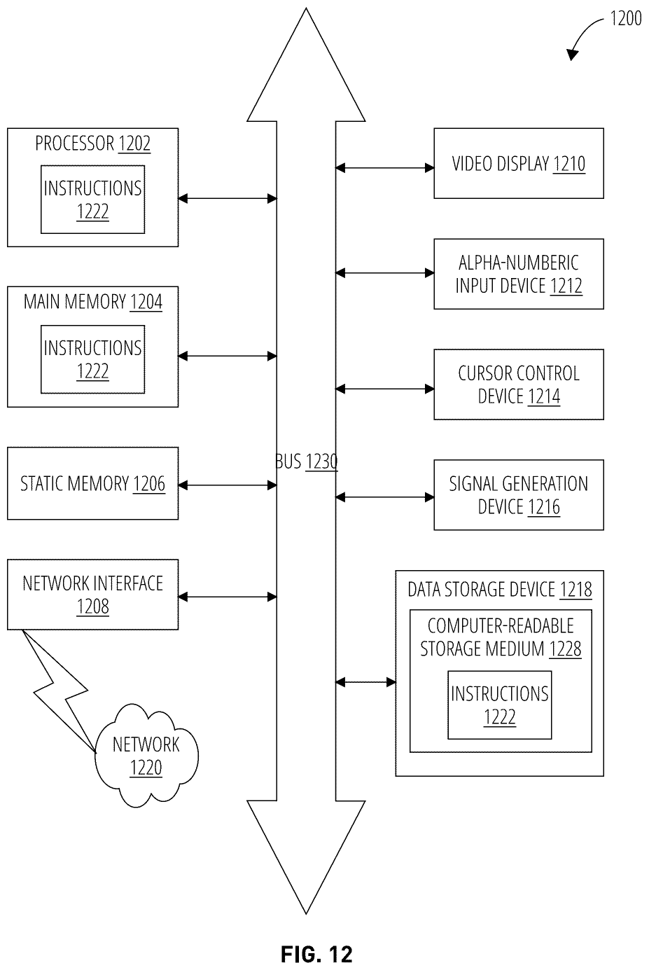

FIG. 12 illustrates an embodiment of a diagrammatic representation of a computing device associated with a decentralized computing platform, according to one embodiment. In one implementation, the processing device 1200 may be a part of any computing device, such as a processing packlet as described in one or more of FIGS. 1-6, or any combination thereof. In another implementation, the processing device 1200 may be external to a computing platform and may be designed to control the computing platform. In at least one embodiment, the processing device 1200 may perform the method 700. Example processing device 1200 may be connected to other processing devices in a LAN, an intranet, an extranet, and/or the Internet. The processing device 1200 may be a personal computer (PC), a set-top box (STB), a server, a network router, switch or bridge, or any device capable of executing a set of instructions (sequential or otherwise) that specify actions to be taken by that device. Further, while only a single example processing device is illustrated, the term “processing device” shall also be taken to include any collection of processing devices (e.g., computers) that individually or jointly execute a set (or multiple sets) of instructions to perform any one or more of the methods discussed herein.

Example processing device 1200 may include a processor 1202 (e.g., a CPU), a main memory 1204 (e.g., read-only memory (ROM), flash memory, dynamic random access memory (DRAM) such as synchronous DRAM (SDRAM), etc.), a static memory 1206 (e.g., flash memory, static random access memory (SRAM), etc.), and a secondary memory (e.g., a data storage device 1218), which may communicate with each other via a bus 1230.

Processor 1202 represents one or more general-purpose processing devices such as a microprocessor, central processing unit, or the like. More particularly, processor 1202 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1202 may also be one or more special-purpose processing devices such as an application specific integrated circuit (ASIC), a field programmable gate array (FPGA), a digital signal processor (DSP), network processor, or the like. In accordance with one or more aspects of the present disclosure, processor 1202 may be configured to execute instructions to perform operations of processing or memory packlets as described herein, including the operations of the method 700.

Example processing device 1200 may further comprise a network interface device 1208, which may be communicatively coupled to a network 1220. Example processing device 1200 may further comprise a video display 1210 (e.g., a liquid crystal display (LCD), a touch screen, or a cathode ray tube (CRT)), an alphanumeric input device 1212 (e.g., a keyboard), an input control device 1214 (e.g., a cursor control device, a touch-screen control device, a mouse), and a signal generation device 1216 (e.g., an acoustic speaker).

Data storage device 1218 may include a computer-readable storage medium (or, more specifically, a non-transitory computer-readable storage medium) 1228 on which is stored one or more sets of executable instructions 1222. In accordance with one or more aspects of the present disclosure, executable instructions 1222 may comprise executable instructions to perform operations of processing or memory packlets as described herein, including the operations of the method 700.

Executable instructions 1222 may also reside, completely or at least partially, within main memory 1204 and/or within processor 1202 during execution thereof by example processing device 1200, main memory 1204 and processor 1202 also constituting computer-readable storage media. Executable instructions 1222 may further be transmitted or received over a network via network interface device 1208.

While the computer-readable storage medium 1228 is shown in FIG. 12 as a single medium, the term “computer-readable storage medium” should be taken to include a single medium or multiple media (e.g., a centralized or distributed computing platform, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present invention. Thus, the specific details set forth are merely exemplary. Particular embodiments may vary from these exemplary details and still be contemplated to be within the scope of the present disclosure.

Reference throughout this specification to “one embodiment” or “an embodiment” indicates that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of embodiments of the invention should, therefore, be determined with reference to the appended claims, along with the full scope of equivalents to which such claims are entitled.

What is claimed is:

1. A device comprising:
a first plurality of optical interfaces each configured to couple to a different processing device;
a first plurality of optical-to-electrical (O/E) interfaces each coupled to at least one of the first plurality of optical interfaces; and
a first plurality of memory devices each coupled to at least one of the first plurality of O/E interfaces.

2. The device of claim 1, wherein each of the first plurality of memory devices are coupled to a different one of the first plurality of O/E interfaces.

3. The device of claim 1, further comprising a first plurality of waveguides each coupled to at least one of the first plurality of O/E interfaces, wherein the first plurality of waveguides couple the first plurality of O/E interfaces to a first optical interface of the first plurality of optical interfaces.

4. The device of claim 3, further comprising a second plurality of waveguides each coupled to at least one of the first plurality of O/E interfaces, wherein the second plurality of waveguides couple the first plurality of O/E interfaces to a second optical interface of the first plurality of optical interfaces.

5. The device of claim 3, wherein a first waveguide of the first plurality of waveguides couples a first O/E interface of the first plurality of O/E interfaces and a second O/E interface of the first plurality of O/E interfaces to the first optical interface, wherein the first waveguide combines signals of the first and second O/E interfaces using wavelength division multiplexing (WDM) and the first optical interface separates the signals of the first and second O/E interfaces, and wherein the separated signals of the first and second O/E interfaces are to be transmitted to a processing device via different cores of a multi-core fiber coupled to the first optical interface.

6. The device of claim 1, wherein the device is a dual-sided package comprising a top portion and a bottom portion separated by an interposer, the first plurality of O/E interfaces and the first plurality of memory devices are disposed on the top portion, and wherein the bottom portion comprises:
a second plurality of optical interfaces each configured to couple to different processing devices;
a second plurality of O/E interfaces each coupled to at least one of the second plurality of optical interfaces; and
a second plurality of memory devices each coupled to at least one of the second plurality of O/E interfaces.

7. A system comprising:
a first set of processing resources comprising one or more processors coupled to a first optical interface;
a first set of memory resources comprising a second optical interface coupled to the first optical interface, the first set of memory resources additionally comprising:
a first plurality of optical-to-electrical (O/E) interfaces each coupled to the second optical interface; and
a first plurality of memory devices each coupled to one of the first plurality of O/E interfaces.

8. The system of claim 7, wherein each memory device of the first plurality of memory devices is coupled to a different one of the first plurality of O/E interfaces.

9. The system of claim 7, wherein the first set of memory resources comprises a dual-sided package comprising a top portion and a bottom portion separated by an interposer, wherein the first plurality of O/E interfaces and the first plurality of memory devices are disposed on the top portion, and wherein the bottom portion comprises:
a second plurality of O/E interfaces each coupled to a third optical interface of the first set of memory resources, the third optical interface coupled to a fourth optical interface of the first set of processing resources; and
a second plurality of memory devices each coupled to one of the second plurality of O/E interfaces.

10. The system of claim 7, wherein the first set of memory resources comprises a plurality of waveguides that each couple a plurality of the first plurality of O/E interfaces to the second optical interface.

11. The system of claim 7, wherein the first set of memory resources comprises a third optical interface different from the second optical interface, and wherein each of the first plurality of O/E interfaces are coupled to a third optical interface.

12. The system of claim 11, wherein the third optical interface is coupled to a fourth optical interface of a second set of processing resources different from the first set of processing resources.

13. The system of claim 12, wherein the first set of memory resources comprises a fifth optical interface different from the second and third optical interfaces, wherein each of the first plurality of O/E interfaces are coupled to the fifth optical interface, and wherein the fifth optical interface is coupled to a sixth optical interface of a third set of processing resources different from the first and second sets of processing resources.

14. The system of claim 13, wherein the first set of memory resources comprises a seventh optical interface different from the second, third, and fifth optical interfaces, wherein each of the first plurality of O/E interfaces are coupled to the seventh optical interface, and wherein the seventh optical interface is coupled to an eighth optical interface of a fourth set of processing resources different from the first, second, and third sets of processing resources.

15. The system of claim 7, wherein the first set of processing resources comprises a third optical interface different from the first optical interface, and wherein the third optical interface is coupled to a fourth optical interface of a second set of memory resources different from the first set of memory resources.

16. The system of claim 15, wherein the first set of processing resources comprises a fifth optical interface different from the first and third optical interfaces, and wherein the fifth optical interface is coupled to a sixth optical interface of a third set of memory resources different from the first and second sets of memory resources.

17. The system of claim 16, wherein the first set of processing resources comprises a seventh optical interface different from the first, third, and fifth optical interfaces, and wherein the seventh optical interface is coupled to an eighth optical interface of a fourth set of memory resources different from the first, second, and third sets of memory resources.

18. A method, comprising:
receiving, by a processing device, a first request to train a first machine learning model (MLM);
causing first computations to be concurrently performed by a first set of processing resources and a second set of processing resources with shared memory from a first set of memory resources, wherein the first and second sets of processing resources and the first set of memory resources being part of a computing platform, and wherein the first computations corresponding to training the first MLM;
receiving, by the processing device after the first request, a second request to train a second MLM and a third request to train a third MLM; and
causing second computations to be concurrently performed by the first and second sets of processing resources using non-shared memory from at least one of the first set of memory resources or a second set of memory resources part of the computing platform, the second computations corresponding to training the second and third MLMs.

19. The method of claim 18, further comprising:
configuring a first logical fabric of a database based on the first request having a first workload requirement, the database comprising the first and second sets of processing resources and the first and second sets of memory resources, wherein the first and second sets of processing resources perform the first computations based on the first logical fabric; and
configuring a second logical fabric of the database different than the first logical fabric based on the second request having a second workload requirement and the third request having a third workload requirement, wherein the first and second sets of processing resources perform the second computations based on the second logical fabric.

20. The method of claim 18, wherein a database comprises the first and second sets of processing resources, the first and second sets of memory resources, and a third set of processing resources coupled to the first set of memory resources, wherein the method further comprises:
configuring a first logical fabric of the database based on the first request having a first workload requirement, wherein the first and second sets of processing resources perform the first computations based on the first logical fabric, and wherein the first logical fabric does not logically connect the third set of processing resources to the first set of memory resources;
receiving, by the processing device after the first request, a fourth request to train a fourth MLM having a second workload requirement larger than the first workload requirement;
configuring a second logical fabric of the database different than the first logical fabric based on the second workload requirement; and
causing third computations to be concurrently performed by the first, second, and third sets of processing resources with shared memory from the first set of memory resources, the third computations corresponding to training the fourth MLM, wherein the first, second, and third sets of processing resources perform the third computations based on the second logical fabric.
